(19) United States
(12) Patent Application Publication
(10) Pub. No.: US 2025/0350938 A1
(43) Pub. Date: Nov. 13, 2025

(54) KEY MANAGEMENT METHOD AND APPARATUS, DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/864,816

(22) PCT Filed: May 13, 2022
(86) PCT No.: PCT/CN2022/092888

§ 371 Date: Nov. 11, 2024

(51) Int. Cl. H04W 12/0433; H04W 12/041; H04W 12/06; H04W 12/72

(52) U.S. Cl. CPC H04W 12/0433; H04W 12/041; H04W 12/06; H04W 12/72

(57) ABSTRACT

A method, apparatus and computer readable medium for key management in a roaming scenario. The key management is performed by: receiving an AKMA key identifier and an AF identifier from an AF, where the AKMA key identifier is used to indicate an AKMA key of a terminal, and the AF identifier is used to indicate the AF; sending the AKMA key identifier and the AF identifier to an AAnF in a home network; receiving AKMA application key information of the AF sent by the AAnF in the home network; and feeding back the AKMA application key information of the AF to the AF.

### CROSS-REFERENCE

The present application is a U.S. National Stage of International Application No. PCT/CN2022/092888, filed on May 13, 2022, the contents of which are incorporated herein by reference in their entirety for all purposes.

### BACKGROUND OF THE INVENTION

At present, authentication and key management for applications (AKMA) based on 3rd generation partnership project (3GPP) credentials have been used as a solution to protect communication between a terminal and an application function (AF) in scenarios such as a proximity based service (ProSe) and a message within 5th generation (MSGin5G) mobile communication technology.

### SUMMARY OF THE INVENTION

Examples of the disclosure provide a key management method and apparatus, a device, and a storage medium, which can be applied in a roaming scenario to perform key request based on a proxy entity in a serving network. The technical solution is as follows.

According to a first of the disclosure, a key management method is provided, applied in a roaming scenario, performed by a proxy entity in a serving network, and including:
receiving an AKMA key identifier and an AF identifier from an AF, where the AKMA key identifier is used to indicate an AKMA key of a terminal, and the AF identifier is used to indicate the AF; and
feeding back AKMA application key information of the AF to the AF.

According to a second aspect of the disclosure, a key management method is provided, applied in a roaming scenario, performed by a network exposure function (NEF) in a serving network, and including:
receiving an AKMA key identifier and an AF identifier from an AF, where the AKMA key identifier is used to indicate an AKMA key of a terminal, and the AF identifier is used to indicate the AF; and
feeding back AKMA application key information of the AF to the AF.

According to a third aspect of the disclosure, a key management method is provided, applied in a roaming scenario, performed by an application function (AF), and including:
receiving a serving network identifier and an AKMA key identifier sent by a terminal;
sending, in a case that the serving network identifier and a home network identifier of the terminal are different, the AKMA key identifier and an AF identifier to a network exposure function (NEF) in a serving network;
receiving AKMA application key information of the AF from the NEF in the serving network, where the AKMA application key information is fed back by the NEF according to the second aspect of the disclosure; and
feeding back an application session establishment response to the terminal.

According to a fourth aspect of the disclosure, a key management method is provided, applied in a roaming scenario, performed by an AAnF in a home network, and including:
receiving an AKMA key identifier and an application function (AF) identifier from a proxy entity in a serving network, where the AKMA key identifier is used to indicate an AKMA key of a terminal, and the AF identifier is used to indicate an AF;
getting an AKMA application key of the AF based on an AKMA key indicated by the AKMA key identifier; and
sending AKMA application key information of the AF to the proxy entity in the serving network, and cause the proxy entity to performs the step of feeding back AKMA application key information of the AF to the AF according to the first aspect of the disclosure.

According to a fifth aspect of the disclosure, a key management method is provided, applied in a roaming scenario, performed by a terminal, and including:
sending a serving network identifier and an AKMA key identifier to an application function (AF), where the serving network identifier is used to trigger the AF to send the AKMA key identifier and an AF identifier to a proxy entity in a serving network in a case that the serving network identifier and a home network identifier are different.

According to a sixth aspect of the disclosure, a proxy entity is provided, the proxy entity includes a communication component, where the communication component is configured to receive an AKMA key identifier and an AF identifier from an AF, where the AKMA key identifier is used to indicate an AKMA key of a terminal, and the AF identifier is used to indicate the AF; and feed back AKMA application key information of the AF to the AF.

According to an seventh aspect of the disclosure, a non-transitory computer readable storage medium is provided, where the non-transitory computer readable storage medium stores executable instructions, and the executable instructions are loaded and executed by a processor, so as to implement the key management method as described in the above aspects.

### BRIEF DESCRIPTION OF DRAWINGS

FIG. 1 shows a schematic diagram of a network architecture of an AKMA service in related art;

FIG. 2 shows a schematic flow diagram of generating a key for an AKMA service in related art;

FIG. 3 shows a schematic diagram of a key management scenario provided by an example of the disclosure;

FIG. 4 shows a schematic diagram of a key management scenario provided by an example of the disclosure;

FIG. 5 shows a flow diagram of a key management method provided by an example of the disclosure;

FIG. 6 shows a flow diagram of a key management method provided by an example of the disclosure;

FIG. 7 shows a flow diagram of a key management method provided by an example of the disclosure;

FIG. 8 shows a flow diagram of a key management method provided by an example of the disclosure;

FIG. 9 shows a flow diagram of a key management method provided by an example of the disclosure;

FIG. 10 shows a flow diagram of a key management method provided by an example of the disclosure;

FIG. 11 shows a flow diagram of a key management method provided by an example of the disclosure;

FIG. 12 shows a structural block diagram of a key management apparatus provided by an example of the disclosure;

FIG. 13 shows a structural block diagram of a key management apparatus provided by an example of the disclosure;

FIG. 14 shows a structural block diagram of a key management apparatus provided by an example of the disclosure;

FIG. 15 shows a structural block diagram of a key management apparatus provided by an example of the disclosure;

FIG. 16 shows a structural block diagram of a key management apparatus provided by an example of the disclosure;

FIG. 17 shows a schematic structural diagram of a communication device provided by an example of the disclosure;

FIG. 18 shows a schematic structural diagram of a network element device provided by an example of the disclosure.

### DETAILED DESCRIPTION OF THE INVENTION

In order to make the objective, technical solutions and advantages of the disclosure clearer, the implementations of the disclosure will be described further in detail with reference to accompanying drawings. Examples will be illustrated in detail here, and instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with the disclosure. On the contrary, they are merely examples of an apparatus and method consistent with some aspects of the disclosure as detailed in the appended claims.

The terms used in the present disclosure are merely for the purpose of describing the particular examples, and are not intended to limit the present disclosure. The singular forms “a,” “the” and “this” used in the present disclosure and the appended claims are also intended to include the plural forms as well, unless the context clearly indicates otherwise. It is to be further understood that a term “and/or” used in this text refers to and contains any and all possible combinations of one or more associated listed items.

It needs to be understood that the terms “first,” “second,” “third” and the like may be employed in the present disclosure to describe various information, but these pieces of information should not be limited to these terms. These terms are merely used to distinguish the same type of information from one another. For example, in a case of not departing from the scope of the present disclosure, first information may also be called second information, and similarly, the second information may also be called the first information. Depending on the context, the word “if” as used here may be interpreted as “at the time of” or “when” or “in response to determining”.

The disclosure relates to the field of communications, in particular to a key management method and apparatus, a device, and a storage medium.

In the related art, there is still no feasible solution for how to provide an AKMA service to non-trusted application function outside a 3GPP service provider domain when faced with a terminal roaming scenario.

Firstly, the relevant technical background involved in the examples of the disclosure is introduced:

### 5th Generation Mobile Communication Technology (5G) System:

The 5G system includes a terminal, an access network, and a core network. The terminal is a device with a wireless transmission and reception function, and the terminal may be deployed on land, water, and in the air, etc. The terminal may be applied to at least one scenario of self driving, remote medical, smart grid, transportation safety, smart city, smart home, etc.

The access network is used to implement access-related functions and can provide a network access function for authorized users in specific areas. The access network forwards control signals and user data between a terminal device and the core network. The access network may include an access network device, and the access network device may be a device that provides access for the terminal device, and may include a radio access network (RAN) device and an AN device. The RAN device is mainly a wireless network device in a 3GPP network, while the AN device may be a non-3GPP defined access network device. In a system using different wireless access technologies, names of the devices with a base station function may vary. For example, in the 5G system, the devices are called an RAN or a next generation node basestation (gNB); and in a long term evolution (LTE) system, the devices are called an Evolved NodeB (eNB or eNodeB).

The core network is responsible for maintaining subscription data of the mobile network, and providing functions such as session management, mobility management, policy management, and security authentication for the terminal. The core network may include the following network elements: a user plane function (UPF), an authentication server function (AUSF), an access and mobility management function (AMF), a session management function (SMF), a network exposure function (NEF), a network function repository function (NRF), a policy control function (PCF), and a unified data management (UDM). Alternatively, the core network may further include an application function (AF) and a unified data repository (UDR). In the example of the disclosure, the UDM and the UDR are collectively referred to as a data management network element.

The AMF is mainly responsible for mobility management in the mobile network, such as user location update, user registration in the network, and user switching. The SMF is mainly responsible for session management in the mobile network, such as session establishment, modification, and release. The UPF is responsible for forwarding and receiving user data in the terminal device, able to receive user data from a data network and transmit same to the terminal device through the access network device, and is also able to receive user data from the terminal device through the access network device and forward the same to the data network. The PCF mainly supports to provide a unified policy framework to control a network behavior, provide a policy rule to a control layer network function, and is responsible for acquiring user subscription information related to policy decisions. The AUSF is used to perform secure authentication of the terminal. The NEF is mainly used to support exposure of capabilities and events. The NRF is used to provide a storage function and a selection function of network function entity information for other network elements. The UDM is used to store user data, such as subscription data and authentication/authorization data. The AF interacts with the 3GPP core network to provide an application layer service, such as providing application layer data routing, providing an access network capability exposure function, interacting with the policy framework to provide policy control, and interacting with an IP multimedia subsystem (IMS) of a 5G network.

The data network (DN) is used to provide a business service for users and may be a private network, such as a local area network; the data network may also be an external network not controlled by operators, such as the Internet; and the data network may further be a proprietary network jointly deployed by the operators, such as an IMS network. The terminal device may access the DN through established protocol data unit (PDU) sessions.

It is to be understood that in some examples of the disclosure, “5G” may also be referred to as “5G new radio (NR)” or “NR,” and the “terminal” may also be referred to as a “terminal device” or “user equipment (UE)”. The technical solutions described in the examples of the disclosure may be applicable to the 5G system, may also be applicable to a subsequent evolution system of the 5G system, and may further be applicable to 6G and a subsequent evolution system.

### Authentication and Key Management for Applications Based on 3GPP Credentials (AKMA) Service:

UE that supports an AKMA service may be based on the security protection of an AKMA process so as to improve the security of data transmission when performing data transmission with an AF that supports the AKMA service. For example, when the AF corresponds to a certain video application server and the UE that supports the AKMA service performs data transmission with the AF, compared to an unprotected transmission method of traditional UE and AF, using of the AKMA service may improve the security of data transmission. For example, please refer to a schematic diagram of a network architecture of the AKAM service shown in FIG. 1. The network architecture shown in FIG. 1 includes the UE 01, the (R) AN 02, the AUSF 03, the AMF 04, the AF 05, the NEF 06, an AKMA anchor function (AAnF) 07 network element and the UDM 08.

In FIG. 1, there are three ways for the UE 01 to communicate with the AF 05: one is for the UE 01 to communicate with the AF 05 through the (R) AN 02 and the AMF 04, one is for the UE 01 to communicate with the AF 05 through the AMF 04, and one is for the UE 01 to communicate directly with the AF 05 through a Ua* interface. The Ua* interface is a communication interface between the UE 01 and the AF 05.

In FIG. 1, in the AKMA service, the AUSF 03 may generate a key of the AKMA service and provide the key of the AKMA service of the UE 01 to the AAnF 07. The key of the AKMA service may be K_{AKMA}, also known as a root key of the AKMA service. The UE 01 side will also generate the same key of the AKMA service by itself, that is, generate the same K_{AKMA}.

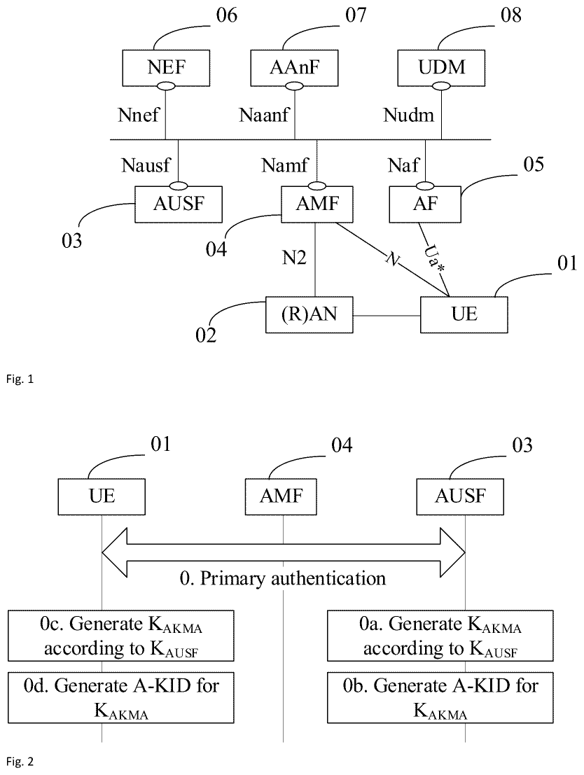

For example, a process of generating the key for AKMA service may be seen in FIG. 2. In a process that the UE 01 registers in the 5G core network, the UE 01 sends a registration request to the AMF 04 through the RAN, the registration request carries identity information of the UE 01, and the AMF 04 selects the AUSF 03 according to the identity information (such as a subscriber concealed identifier (SUCI)) of the UE 01 and sends a message to the AUSF 03 to trigger a primary authentication process (step 0); the AUSF 03 performs authentication on the UE 01 and sends authentication parameters to the AMF 04; and the AMF 04 sends authentication parameters to the UE 01 through the RAN, the UE 01 performs authentication on the AUSF 03 based on the authentication parameters, and sends a response to the AMF 04 through the RAN, the AMF 04 compares the response. If it meets the requirements, authentication is successful. The primary authentication in FIG. 2 refers to a process in which the AUSF 03 and the UE 01 authenticate each other during the registration process. The primary authentication may also be described as bidirectional authentication, as specifically described in the relevant sections of 3GPP TS33.501-g106.1. In FIG. 2, after primary authentication, the AUSF 03 may use an intermediate key such as K_{AUSF} generated during the primary authentication process to generate K_{AKMA} (step 0a) and generate key identification information for K_{AKMA} (step 0b). The key identification information may be used to identify K_{AKMA}, such as K_{AKMA} identifier (A-KID). After primary authentication and before initiating the AKMA service, the UE 01 may use the intermediate key such as K_{AUSF} generated during the primary authentication process to generate K_{AKMA} (step 0c) and generate the key identification information for K_{AKMA} (step 0d). It may be understood that the UE 01 and the AUSF 03 respectively generate the same K_{AUSF}, K_{AKMA}, and the key identification information locally.

In FIG. 1, the AAnF 07 may interact with the AUSF 03, get the key of the AKMA service from the AUSF 03, and generate a communication key between the AF 05 and the UE 01 as well as an expiration time of the communication key according to the key of the AKMA service and an AF identifier. The AAnF 07 may send the communication key and the expiration time of the communication key to the AF 05, so that the AF 05 may use the communication key for data transmission with the UE 01, thus the security of data transmission between the AF 05 and the UE 01 is improved. The communication key between the AF 05 and the UE 01 may be, for example, K_{AF}.

The K_{AF} between different AFs and the same UE may be different, for example, the K_{AF} between an AF1 and UE1 is K_{AF}1, and the K_{AF} between an AF2 and UE1 is K_{AF}2. In FIG. 1, the AF 05 may interact with a 3GPP core network element. For example, the AF may obtain a quality of service (QoS) parameter from the PCF, or the AF provides QoS parameters to the PCF, which can affect the data transmission of application programs. For another example, the AF may interact with the NEF. In a scenario of the AKMA service, the AF gets the communication key between the AF and the UE, as well as the expiration time of the communication key, from the AAnF. The AF may be located inside or outside the 5G core network. In a case that the AF is located inside the 5G core network, the AF may directly interact with the PCF; and in a case that the AF is located outside the 5G core network, the AF may interact with the PCF through the NEF.

An Example of where an AAnFProxy and an NEF Belong to Different Entities:

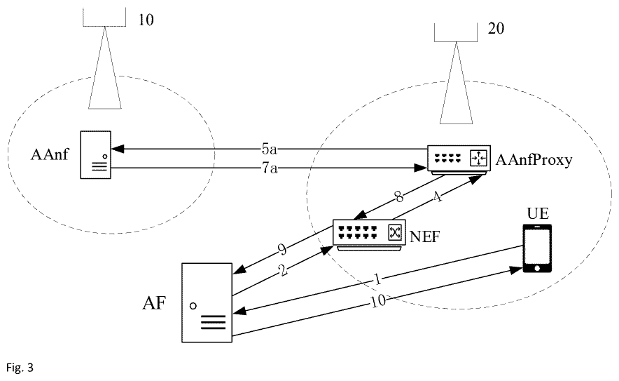

FIG. 3 shows a schematic diagram of a key management system provided by an example of the disclosure. The system includes: at least one terminal (UE), at least one AF, at least one NEF, at least one AAnF, and at least one AAnF proxy entity.

In this example, there is at least one terminal (UE), at least one AF, at least one NEF, at least one AAnF, and at least one AAnF proxy entity (AAnFProxy). The AAnF is located in a home network (10) of the terminal, and the terminal, the NEF, and the AAnFProxy are located in a serving network (20). Alternatively, coverage areas of the home network (10) and the serving network (20) may be different, identical, or overlapping.

In some examples, the AAnFProxy is an entity independent of the NEF, i.e., the AAnFProxy is an entity different from the NEF.

In some examples, the AAnFProxy is an AAnF in the serving network or an AF that is operated and scheduled into the serving network.

In some examples, a terminal type includes, but is not limited to a handheld device, a wearable device, a vehicle-mounted device, and an Internet of things (loT) device. The terminal may be at least one of a mobile phone, a tablet computer, an e-book reader, a laptop, a desktop computer, a television, a game console, an augmented reality (AR) terminal, a virtual reality (VR) terminal, a mixed reality (MR) terminal, a wearable device, a gamepad, or a controller.

In some examples, the terminal is in a roaming scenario.

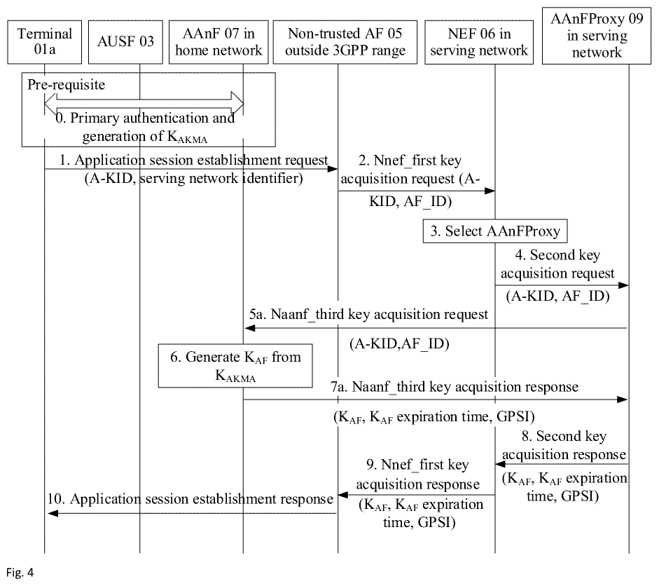

A flow diagram of the key management method in this example is as shown in FIG. 4, and the method includes at least some of the following steps:

step 1: an application session establishment request is sent by a terminal 01a to an AF 05.

Before step 1, as mentioned earlier and as shown in FIG. 2, an AUSF 03 and the terminal 01a perform a primary authentication process (step 0), and the terminal 01a and the AUSF 03 respectively generate the same AUSF key, AKMA key, and AKMA key identifier locally.

Alternatively, the AUSF key is K_{AUSF}. Alternatively, the AKMA key is K_{AKMA}. Alternatively, the AKMA key identifier is A-KID.

Before step 1, the terminal 01a and the AF 05 need to know whether to use AKMA.

Alternatively, this is implicitly specific to the terminal and the AF, or explicitly indicated by the AF to the terminal.

The application session establishment request is used to trigger establishment of an application session, and is sent by the terminal to the AF.

In some examples, the AF is a non-trusted application function outside a 3GPP service provider domain.

In some examples, the application session establishment request includes the A-KID and/or a serving network identifier of the terminal. A-KID is used to indicate identification information of the AKMA key such as K_{AKMA}, and the serving network identifier is used to indicate identification information of a serving network of the terminal.

TS 33.535 defines that the A-KID uses a format of a network access identifier (NAI) specified in Clause 2.2 of requests for comments (RFC) 7542 of the international Internet engineering task force (IETF), such as user name @security domain. The user name section needs to contain a routing indicator (RID) and an AKMA temporary UE identifier (A-TID), and the security domain section needs to contain a home network identifier.

In some examples, the application session establishment request includes the A-KID, and the A-KID carries the serving network identifier of the terminal; alternatively, the application session establishment request includes the A-KID and the serving network identifier of the terminal; alternatively, the application session establishment request includes the A-KID, and the terminal sends the serving network identifier of the terminal before or after the application session establishment request. Alternatively, the serving network identifier indicates the presence of a corresponding application session establishment request or A-KID.

In some examples, the terminal generates an AKMA application Key (K_{AF}) before or after sending the application session establishment request.

Step 2: a first key acquisition request is sent by the AF 05 to an NEF 06 in the serving network.

In a case that the received serving network identifier of the terminal is the same as a home network identifier of the terminal, K_{AF} is gotten by the AF from an AAnF as described in clause 6.3 of TS 33.535.

In a case that the received serving network identifier of the terminal is different from the home network identifier of the terminal, the first key acquisition request is sent by the AF to the NEF in the serving network. The first key acquisition request is used to request to acquire AF key information from the NEF in the serving network. Alternatively, the first key acquisition request is AKMA_ApplicationKey_Get Request of a Service-based interface exhibited by NEF (Nnef) interface, namely, Nnef_AKMA_ApplicationKey_Get Request.

In some examples, the first key acquisition request includes the A-KID and/or an AF identifier (AF_ID). AF_ID is identification information used to indicate the AF and contains a fully qualified domain name (FQDN) and a Ua* security protocol identifier of the AF. The Ua* security protocol identifier is used to indicate a security protocol that the AF will use together with the terminal.

In a case that the system is not supported by a common application programming interface (API) framework (CAPIF), an API termination service point is locally configured by the AF for a service provided by the AAnFProxy in the serving network. In the case that the system is not supported by the CAPIF, the AF contains service API information from a CAPIF core function, and discovers availability of a response through service API event notification or service as defined in TS 23.222.

Step 3: AAnFProxy is selected by the NEF 06 in the serving network.

At least one AAnFProxy is selected by the NEF in the serving network to process an AKMA key request.

In some examples, at least one AAnFProxy is selected by the NEF in the serving network according to a local preset policy; alternatively, at least one AAnFProxy is discovered or selected by the NEF by using a network function repository function (NRF) in the serving network.

In some examples, the NEF delegates a service communication proxy (SCP) to discover and select at least one AAnFProxy. In this case, all available factors are sent by AAnFProxy NF to the SCP.

In some examples, the NEF is locally configured with AAnFProxy and/or AAnF information in the home network.

Step 4: a second key acquisition request is sent by the NEF 06 in the serving network to the selected AAnFProxy 09.

After selecting at least one AAnFProxy or in a case that the NEF is locally configured with AAnFProxy information, the second key acquisition request is sent to the AAnFProxy based on trigger of a first key acquisition request. The second key acquisition request is used to trigger the AAnFProxy to send a third key acquisition request. Alternatively, the second key acquisition request is AKMA_ApplicationKey Request.

In some examples, the second key acquisition request includes the A-KID and/or an AF identifier (AF_ID).

Step 5a: a third key acquisition request is sent by the AAnFProxy 09 in the serving network to an AAnF 07 in the home network.

In some examples, the AAnF in the home network is discovered or selected by the AAnFProxy by using an NRF in the serving network and an NRF in the home network.

In some examples, the AAnFProxy delegates the SCP to discover or select the AAnF in the home network. In this case, all available factors are sent by the AAnF NF to the SCP.

In some examples, the AAnFProxy is locally configured with the AAnF information in the home network.

After selecting the AAnF in the home network, or in a case that the AAnFProxy is locally configured with the AAnF information in the home network, or in a case that the NEF is locally configured with the AAnF information in the home network, the third key acquisition request is sent by the AAnFProxy to the AAnF in the home network based on trigger of the second key acquisition request. Alternatively, the third key acquisition request is AKMA_ApplicationKey_Get Request of a Service-based interface exhibited by AAnF (Naanf) interface, namely, Naanf_AKMA_ApplicationKey_Get Request.

In some examples, the third key acquisition request includes the A-KID and/or the AF identifier (AF_ID).

In some examples, K_{AF} is generated by the AAnFProxy.

In some examples, K_{AF} is generated by the AAnFProxy according to the received A-KID and AF_ID.

Step 6: K_{AF} is generated by the AAnF 07 in the home network from K_{AKMA}.

In some examples, whether the AAnF in the home network may provide a service to the AF and the proxy entity in the serving network is determined by the AAnF according to authorization information or policy provided by the AF_ID. This example makes illustration by taking an example of determining that the AAnF may provide the service to the AF.

In some examples, the authorization information or policy is provided by a local policy or an NRF in the home network.

In a case of determining that the AAnF may provide the service to the AF and the proxy entity in the serving network, the AAnF performs the following process; and in a case that the AAnF cannot provide the service to the AF and the proxy entity in the service network, the AAnF rejects the following process.

In some examples, AAnF determines whether there is a corresponding K_{AKMA} locally according to a current A-KID identifier.

In a case that the AAnF does not have the K_{AKMA} corresponding to A-KID, the AAnF sends an error response; and in a case that the AAnF has the K_{AKMA} corresponding to A-KID, the K_{AF} is gotten by the AAnF from the K_{AKMA}. A key source of the K_{AF} needs to be executed in accordance with Annex A.4 of TS 33.535.

Step 7a: a third key acquisition response is sent by the AAnF 07 to the AAnFProxy 09 in the serving network.

The third key acquisition response is response information of the AAnF to the received third key acquisition request, and is used to instruct the AAnFProxy to send the second key acquisition response. Alternatively, the third key acquisition response is AKMA_ApplicationKey_Get Response of the Naanf interface, namely, Naanf_AKMA_ApplicationKey_Get Response.

In some examples, in a case that the AAnF has the K_{AKMA} corresponding to the A-KID, a third key acquisition response is sent by the AAnF to the AAnFProxy in the serving network.

In some examples, the third key acquisition response includes AKMA application key information of the AF.

In some examples, in a case that the AAnF does not have the K_{AKMA} corresponding to the A-KID, an error response is sent by the AAnF to the AAnFProxy in the serving network.

In some examples, the AKMA application key information of the AF includes at least one of the following information:
K_{AF};
expiration time (Exp Time) of the K_{AF};
subscription permanent identifier (SUPI) of the terminal; or
the error response.

Step 8: a second key acquisition response is sent by the AAnFProxy 09 in the serving network to the NEF 06.

The AAnFProxy in the serving network triggers to send the second key acquisition response to the NEF based on the received third key acquisition response or the generated K_{AF}, and the second key acquisition response is used to trigger the NEF to send a first key acquisition response. Alternatively, the second key acquisition response is AKMA_ApplicationKey Response.

In some examples, the second key acquisition response includes key information of the K_{AF} in the third key acquisition response received by the AAnFProxy or key information of the generated K_{AF}.

In some examples, in a case that the AAnFProxy does not receive the K_{AF} from the AAnF or cannot generate K_{AF}, the AAnFProxy sends an error response to the NEF.

Step 9: the first key acquisition response is sent by the NEF 06 in the serving network to the AF 05.

The NEF in the serving network triggers to send the first key acquisition response to the AF based on the received second key acquisition response, and the first key acquisition response is used to trigger the AF to send an application session establishment response. Alternatively, the first key acquisition response is AKMA_ApplicationKey_Get Response of the Nnef interface, namely, Nnef_AKMA_ApplicationKey_Get Response.

In some examples, the first key acquisition response includes AKMA application key information of the AF in the second key acquisition response received by the NEF.

In some examples, the NEF converts the received SUPI into a generic public subscription identifier (GPSI) and sends the GPSI to the AF.

In some examples, in a case that the NEF does not receive the K_{AF} from the AAnFProxy, the NEF sends an error response to the AF.

In some examples, the AF is a non-trusted application function outside a 3GPP service provider domain.

Step 10: the application session establishment response is sent by the AF 05 to the terminal.

The AF triggers to send the application session establishment response to the terminal based on the received first key acquisition response. The application session establishment response is response information of the AF to a received application session establishment request or A-KID from the terminal.

In some examples, if it is determined in step 6 that the AAnF in the home network cannot provide the service to the AF, the AF rejects application session establishment and sends or does not send the application session establishment response to the terminal. Alternatively, the application session establishment response indicates that an AKMA key request fails.

Alternatively, the application session establishment response includes a reason for the application session establishment failure.

In some examples, if the application session establishment fails, after the terminal receives the application session establishment response or in a case that the terminal does not receive the application session establishment response within time x, the terminal triggers a new application session establishment request to the AF by using the latest A-KID, and repeats at least some of the above steps.

In some examples, a value of x is predefined by the communication protocol, configured by the terminal, configured by the AF, or pre-configured.

In some examples, if the first key acquisition response indicates that the application session establishment is successful, the AF accepts the application session establishment and sends the application session establishment response to the terminal. Alternatively, the application session establishment response indicates that an AKMA key request is successful.

In some examples, the AF is a non-trusted application function outside a 3GPP service provider domain.

To sum up, this example provides the key management method. By interaction among the proxy entity in the serving network, the NEF, the AAnF in the home network and the AF outside the 3GPP service provider domain, an application key request and an application key response can be realized, so that the terminal and the AF outside the 3GPP service provider domain perform an AKMA service.

An Example of where an AAnFProxy Belongs to a Part of an NEF:

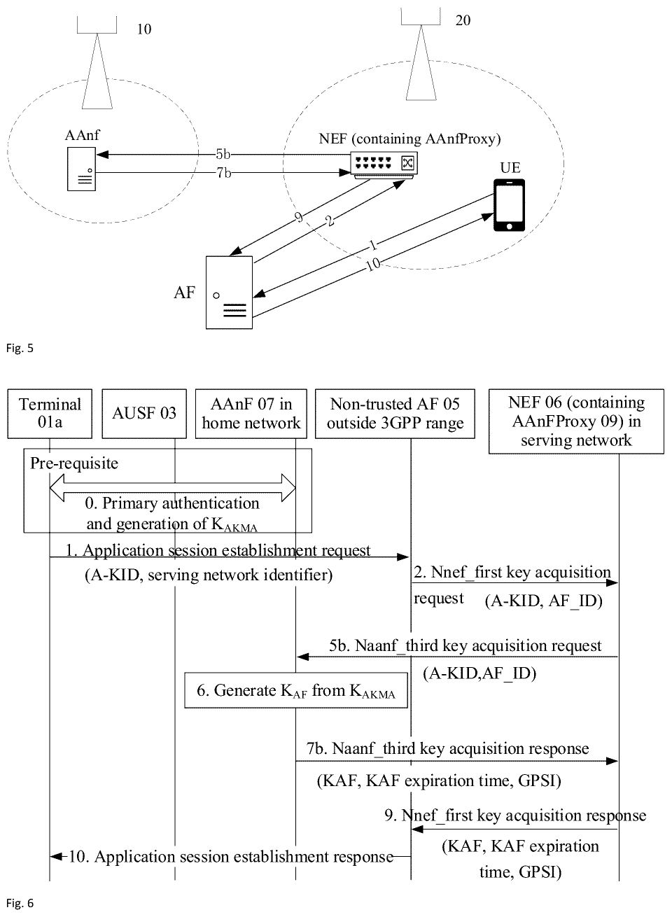

FIG. 5 shows a schematic diagram of a key management system provided by an example of the disclosure. The system includes: at least one terminal (UE), at least one AF, at least one NEF and at least one AAnF.

In this example, there is at least one terminal (UE), at least one AF, at least one NEF, and at least one AAnF. The AAnF is located in a home network (10) of the terminal, and the terminal and the NEF are located in a serving network (20). Alternatively, coverage areas of the home network (10) and the serving network (20) may be different, identical, or overlapping.

In some examples, at least one AAnFProxy is integrated in the NEF, that is, the AAnFProxy is a part of the NEF. Alternatively, the AAnFProxy is the NEF.

In some examples, a terminal type includes, but is not limited to a handheld device, a wearable device, a vehicle-mounted device, and an loT device. The terminal may be at least one of a mobile phone, a tablet computer, an e-book reader, a laptop, a desktop computer, a television, a game console, an augmented reality (AR) terminal, a virtual reality (VR) terminal, a mixed reality (MR) terminal, a wearable device, a gamepad, or a controller.

In some examples, the terminal is in a roaming scenario.

A flow diagram of the key management method in this example is as shown in FIG. 6, and the method includes at least some of the following steps:

step 1: an application session establishment request is sent by a terminal 01a to an AF 05.

Before step 1, as mentioned earlier and as shown in FIG. 2, an AUSF 03 and the terminal 01a perform a primary authentication process (step 0), and the terminal 01a and the AUSF 03 respectively generate the same AUSF key, AKMA key, and AKMA key identifier locally. Alternatively, the AUSF key is K_{AUSF}. Alternatively, the AKMA key is K_{AKMA}. Alternatively, the AKMA key identifier is A-KID.

Before step 1, the terminal 01a and the AF 05 need to know whether to use AKMA. Alternatively, this is implicitly specific to the terminal and the AF, or explicitly indicated by the AF to the terminal.

The application session establishment request is used to trigger establishment of an application session, and is sent by the terminal to the AF.

In some examples, the AF is a non-trusted application function outside a 3GPP service provider domain.

In some examples, the application session establishment request includes the A-KID and/or a serving network identifier of the terminal. A-KID is used to indicate identification information of the AKMA key such as K_{AKMA}, and the serving network identifier is used to indicate identification information of a serving network of the terminal.

TS 33.535 defines that A-KID uses an NAI format specified in clause 2.2 of IETF RFC 7542, such as username @security domain. The username section needs to contain an RID and an A-TID, and the security domain section needs to contain a home network identifier.

In some examples, the application session establishment request includes the A-KID, and the A-KID carries the serving network identifier of the terminal; alternatively, the application session establishment request includes the A-KID and the serving network identifier of the terminal; alternatively, the application session establishment request includes the A-KID, and the terminal sends the serving network identifier of the terminal before or after the application session establishment request. Alternatively, the serving network identifier indicates the presence of a corresponding application session establishment request or A-KID.

In some examples, the terminal generates an AKMA application Key (K_{AF}) before or after sending the application session establishment request.

Step 2: a first key acquisition request is sent by the AF 05 to an NEF 06 in the serving network.

In a case that the received serving network identifier of the terminal is the same as a home network identifier of the terminal, K_{AF} is gotten by the AF from an AAnF as described in clause 6.3 of TS 33.535.

In a case that the received serving network identifier of the terminal is different from the home network identifier of the terminal, the first key acquisition request is sent by the AF to the NEF in the serving network. The first key acquisition request is used to request to acquire AF key information from the NEF in the serving network. Alternatively, the first key acquisition request is AKMA_ApplicationKey_Get Request of an Nnef interface, namely, Nnef_AKMA_ApplicationKey_Get Request.

In some examples, the NEF in the serving network is decided by the AF based on the serving network identifier.

In some examples, the first key acquisition request includes the A-KID and/or an AF_ID. The AF_ID is identification information used to indicate the AF and contains a FQDN and a Ua* security protocol identifier of the AF. The Ua* security protocol identifier is used to indicate a security protocol that the AF will use together with the terminal.

In a case that the system is not supported by a CAPIF, an API termination service point is locally configured by the AF for a service provided by the AAnFProxy in the serving network. In the case that the system is not supported by the CAPIF, the AF contains service API information from a CAPIF core function, and discovers availability of a response through service API event notification or service as defined in TS 23.222.

Step 5b: a third key acquisition request is sent by the AAnFProxy 09 in the serving network to an AAnF 07 in the home network.

in some examples, the AAnF in the home network is discovered or selected by the NEF containing the AAnFProxy by using an NRF in the serving network and an NRF in the home network.

In some examples, the NEF containing the AAnFProxy delegates the SCP to discover or select the AAnF in the home network. In this case, all available factors are sent by the AAnF NF to the SCP.

In some examples, the NEF containing the AAnFProxy is locally configured with the AAnF information in the home network.

After selecting the AAnF in the home network, or in a case that the NEF containing the AAnFProxy is locally configured with the AAnF information in the home network, the third key acquisition request is sent by the NEF containing the AAnFProxy to the AAnF in the home network based on trigger of the received first key acquisition request. Alternatively, the third key acquisition request is AKMA_ApplicationKey_Get Request of an Naanf interface, namely, Naanf_AKMA_ApplicationKey_Get Request.

In some examples, the third key acquisition request includes the A-KID and/or the AF_ID.

In some examples, K_{AF} is generated by the NEF.

In some examples, K_{AF} is generated by the NEF according to the received A-KID and AF_ID.

Step 6: K_{AF} is generated by the AAnF 07 in the home network from K_{AKMA}.

In some examples, whether the AAnF in the home network may provide a service to the AF and the proxy entity in the serving network is determined by the AAnF according to authorization information or policy provided by the AF_ID. This example makes illustration by taking an example of determining that the AAnF may provide the service to the AF.

In some examples, the authorization information or policy is provided by a local policy or an NRF in the home network.

In a case of determining that the AAnF may provide the service to the AF and the proxy entity in the serving network, the AAnF performs the following process; and in a case that the AAnF cannot provide the service to the AF and the proxy entity in the service network, the AAnF rejects the following process.

In some examples, AAnF determines whether there is a corresponding K_{AKMA} locally according to a current A-KID identifier.

In a case that the AAnF does not have the K_{AKMA} corresponding to A-KID, the AAnF sends an error response; and in a case that the AAnF has the K_{AKMA} corresponding to A-KID, the K_{AF} is gotten by the AAnF from the K_{AKMA}. A key source of the K_{AF} needs to be executed in accordance with Annex A.4 of TS 33.535.

Step 7b: a third key acquisition response is sent by the AAnF 07 to the AAnFProxy 09 in the serving network.

The third key acquisition response is response information of the AAnF to the received third key acquisition request, and is used to instruct the NEF containing the AAnFProxy to send the first key acquisition response. Alternatively, the third key acquisition response is AKMA_ApplicationKey_Get Response of the Naanf interface, namely, Naanf_AKMA_ApplicationKey_Get Response.

In some examples, in a case that the AAnF has the K_{AKMA} corresponding to the A-KID, a third key acquisition response is sent by the AAnF to the NEF containing the AAnFProxy in the serving network.

In some examples, the third key acquisition response includes AKMA application key information of the AF.

In some examples, in a case that the AAnF does not have the K_{AKMA} corresponding to the A-KID, an error response is sent by the AAnF to the NEF containing the AAnFProxy in the serving network.

In some examples, the AKMA application key information of the AF includes at least one of the following information:
K_{AF};
an expiration time of the K_{AF};
SUPI; or
the error response.

Step 9: the first key acquisition response is sent by the NEF 06 in the serving network to the AF 05.

The NEF containing the AAnFProxy in the serving network triggers to send the first key acquisition response to the AF based on the received third key acquisition response or the generated K_{AF}, and the first key acquisition response is used to trigger the AF to send an application session establishment response. Alternatively, the first key acquisition response is AKMA_ApplicationKey_Get Response of the Nnef interface, namely, Nnef_AKMA_ApplicationKey_Get Response.

In some examples, the first key acquisition response includes key information of the K_{AF}, which is in the third key acquisition response received by the NEF. Or, the first key acquisition response includes key information of the generated K_{AF}.

In some examples, the NEF converts the received SUPI into a GPSI and sends the GPSI to the AF.

In some examples, in a case that the NEF does not receive the K_{AF} from the AAnFProxy or cannot generate K_{AF}, the NEF sends an error response to the AF.

In some examples, the AF is a non-trusted application function outside a 3GPP service provider domain.

Step 10: the application session establishment response is sent by the AF 05 to the terminal 01a.

The AF triggers to send the application session establishment response to the terminal based on the received first key acquisition response. The application session establishment response is response information of the AF to a received application session establishment request or A-KID from the terminal.

In some examples, if it is determined in step 6 that the AAnF in the home network cannot provide the service to the AF, the AF rejects application session establishment and sends or does not send the application session establishment response to the terminal. Alternatively, the application session establishment response indicates that an AKMA key request fails. Alternatively, the application session establishment response includes a reason for the application session establishment failure.

In some examples, if the application session establishment fails, after the terminal receives the application session establishment response or in a case that the terminal does not receive the application session establishment response within a certain duration, the terminal triggers a new application session establishment request to the AF by using the latest A-KID, and repeats at least some of the above steps.

In some examples, if the first key acquisition response indicates that the application session establishment is successful, the AF accepts the application session establishment and sends the application session establishment response to the terminal. Alternatively, the application session establishment response indicates that an AKMA key request is successful.

In some examples, the AF is a non-trusted application function outside a 3GPP service provider domain.

To sum up, this example provides the key management method. By interaction among the proxy entity in the serving network, the NEF, the AAnF in the home network and the AF outside the 3GPP service provider domain, an application key request and an application key response can be realized, so that the terminal and the AF outside the 3GPP service provider domain perform an AKMA service.

### An Example of a Key Management Method Performed by a Proxy Entity:

FIG. 7 shows a schematic diagram of a key management method provided by an example of the disclosure. This example takes the application of the method to a proxy entity 010 in a serving network as an example for explanation. The method includes at least part of the following steps:

Step 710: an AKMA key identifier and an AF identifier from an AF 05 are received.

The AKMA key identifier is used to indicate an AKMA key, namely K_{AKMA}, of a terminal, and the AF identifier is used to indicate the AF. Alternatively, the AKMA key identifier is A-KID. Alternatively, the AF identifier is an AF_ID.

In some examples, a first key acquisition request sent by the AF is received by the proxy entity, and the first key acquisition request carries the AKMA key identifier and the AF identifier.

In some examples, the proxy entity is a part of an NEF in a serving network. Alternatively, the proxy entity is the NEF.

In some examples, a second key acquisition request sent by the NEF in the serving network is received by the proxy entity, and the second key acquisition request is a key acquisition request sent by the NEF in the serving network after receiving a first key acquisition request sent by the AF.

In some examples, both the first key acquisition request and the second key acquisition request carry the AKMA key identifier and the AF identifier.

In some examples, the proxy entity is an entity different from the NEF in the serving network, that is, the proxy entity is an entity independent of the NEF.

In some examples, the proxy entity is a proxy network element. Alternatively, the proxy entity is an AAnFProxy.

In some examples, an AKMA application key of the AF is generated by the AAnFProxy.

In some examples, the AKMA application key of the AF is generated by the AAnFProxy according to the received AKMA key identifier and AF identifier.

Step 730: the AKMA key identifier and the AF identifier are sent to an AAnF 07 in a home network.

The AKMA key identifier and AF identifier received by the proxy entity trigger the proxy entity to send the AKMA key identifier and the AF identifier to the AAnF in the home network.

In some examples, a third key acquisition request is sent by the proxy entity to the AAnF in the home network, the third key acquisition request is triggered and sent by the proxy entity after receiving the AKMA key identifier and the AF identifier from the AF, and the third key acquisition request carries the AKMA key identifier and the AF identifier.

In some examples, step 730 is an optional step.

Step 750: AKMA application key information of the AF from the AAnF 07 in the home network is received.

In some examples, the AKMA application key information of the AF includes at least one of the following information:
the AKMA application key of the AF;
an Exp Time of the AKMA application key;
an SUPI of a terminal; or
an error response.

In some examples, a third key acquisition response from the AAnF in the home network is received by the proxy entity, and the third key acquisition response carries the AKMA application key information of the AF.

In some examples, step 750 is an optional step.

Step 770: the AKMA application key information of the AF is fed back to the AF 05.

After receiving the AKMA application key information of the AF from the AAnF in the home network or generating the AKMA application key of the AF, the proxy entity triggers feedback of the AKMA application key information of the AF to the AF.

In some examples, a first key acquisition response is sent by the proxy entity to the AF, and the first key acquisition response carries the AKMA application key information of the AF.

In some examples, a second key acquisition response is sent by the proxy entity to the NEF in the serving network, and the second key acquisition response is used to trigger the NEF to send the first key acquisition response to the AF. Alternatively, both the first key acquisition response and the second key acquisition response carry the AKMA application key information of the AF.

In some examples, the NEF converts the received SUPI into a GPSI and sends the GPSI to the AF.

In some examples, in a case that the NEF does not receive the AKMA application key of the AF from the proxy entity, the NEF sends an error response to the AF.

In some examples, the AF is a non-trusted application function outside a 3GPP service provider domain.

To sum up, the example of the disclosure provides the key management method. By interaction between the proxy entity and the AAnF as well as the AF in the home network, an application key request and an application key response can be realized, so that the proxy entity can acquire the AKMA application key information of the AF outside the 3GPP service provider domain.

### An Example of a Key Management Method Performed by an NEF:

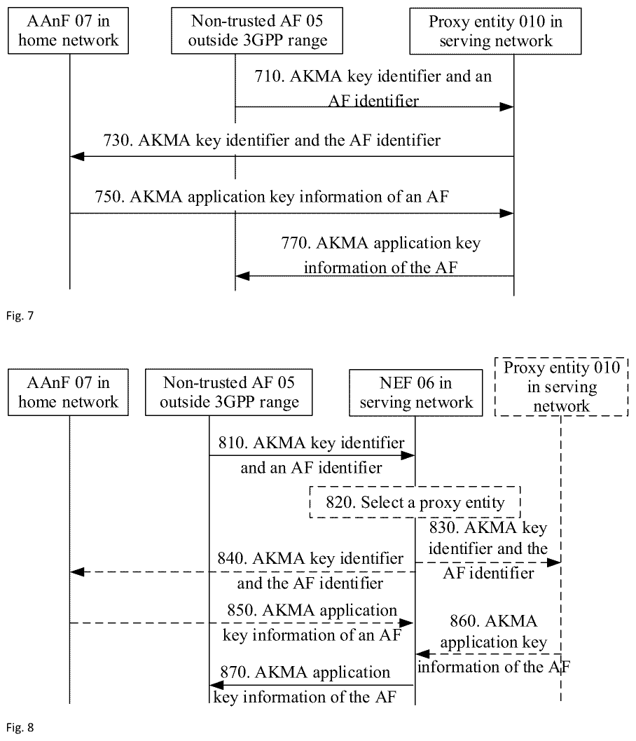

FIG. 8 shows a schematic diagram of a key management method provided by an example of the disclosure. This example takes the application of the method to an NEF 06 in a serving network as an example for explanation. The method includes at least part of the following steps:

Step 810: an AKMA key identifier and an AF identifier from an AF 05 are received.

The AKMA key identifier is used to indicate an AKMA key, such as K_{AKMA}, of a terminal, and the AF identifier is used to indicate the AF. Alternatively, the AKMA key identifier is A-KID. Alternatively, the AF identifier is an AF_ID.

In some examples, a first key acquisition request sent by the AF is received by the NEF, and the first key acquisition request carries the AKMA key identifier and the AF identifier.

In some examples, a proxy entity is integrated in the NEF. Alternatively, the proxy entity is a proxy network element. Alternatively, the proxy entity is an AAnFProxy.

In some examples, the NEF and the proxy entity are different entities in the serving network. Alternatively, the proxy entity is an AAnFProxy.

In some examples, an AKMA application key of the AF is generated by the NEF.

In some examples, the AKMA application key of the AF is generated by the NEF according to the received AKMA key identifier and AF identifier.

Step 820: the proxy entity 010 is selected in the serving network.

In a case that the NEF is different from the proxy entity, at least one proxy entity is selected by the NEF in the serving network to process an AKMA key request. Alternatively, the proxy entity is an AAnFProxy.

In some examples, at least one proxy entity is selected by the NEF in the serving network according to a local preset policy; or, at least one proxy entity is discovered or selected by the NEF by using an NRF in the serving network.

In some examples, the NEF delegates an SCP to discover and select at least one proxy entity. In this case, all available factors are sent by the proxy entity to the SCP.

In some examples, the NEF is locally configured with the proxy entity and/or AAnF information in the home network.

In some examples, step 820 is an optional step.

Step 830: the AKMA key identifier and the AF identifier are sent to the proxy entity 010.

In a case that the NEF is different from the proxy entity, the AKMA key identifier and the AF identifier are sent by the NEF to the proxy entity.

In some examples, a second key acquisition request is sent by the NEF to the proxy entity in the serving network, the second key acquisition request is a key acquisition request sent by the NEF in the serving network after receiving a first key acquisition request sent by the AF, and the second key acquisition request is used to trigger the proxy entity to send a third key acquisition request to an AAnF in the home network. Alternatively, the first key acquisition request, the second key acquisition request and the third key acquisition request all carry the AKMA key identifier and the AF identifier.

In some examples, step 830 is an optional step.

Step 840: the AKMA key identifier and the AF identifier are sent to the AAnF 07 in the home network.

In a case that the proxy entity is integrated in the NEF, the AKMA key identifier and the AF identifier are directly sent by the NEF to the AAnF in the home network.

In some examples, the third key acquisition request is sent by the NEF to the AAnF in the home network. Alternatively, the third key acquisition request carries the AKMA key identifier and the AF identifier.

In some examples, step 840 is an optional step.

Step 850: AKMA application key information from the AF 05 is received.

In a case that the proxy entity is integrated in the NEF, the AKMA application key information of the AF from the AAnF in the home network is received by the NEF.

In some examples, a third key acquisition response from the AAnF in the home network is received by the NEF, and the third key acquisition response carries the AKMA application key information of the AF.

In some examples, the AKMA application key information of the AF includes at least one of the following information:
an AKMA application key of the AF;
an Exp Time of the AKMA application key;
an SUPI of a terminal; or
an error response.

In some examples, step 850 is an optional step.

Step 860: key information sent by the proxy entity 010 is received.

In a case that the NEF is different from the proxy entity, the AKMA application key information of the AF sent by the proxy entity is received by the NEF, and the AKMA application key information of the AF sent by the proxy entity to the NEF comes from the AKMA application key information of the AF sent by the AF to the proxy entity.

In some examples, a second key acquisition response from the proxy entity is received by the NEF, and the second key acquisition response is triggered and sent by the proxy entity after receiving a third key acquisition response from the AF. Alternatively, both the second key acquisition response and the third key acquisition response carry the AKMA application key information of the AF.

In some examples, the AKMA application key information of the AF includes at least one of the following information:
the AKMA application key of the AF;
the Exp Time of the AKMA application key;
the SUPI of the terminal; or
the error response.

In some examples, step 860 is an optional step.

Step 870: the AKMA application key information of the AF is fed back to the AF 05.

After receiving the AKMA application key information of the AF or generating the AKMA application key of the AF, the NEF triggers to send the AKMA application key information of the AF to the AF.

In some examples, a first key acquisition response is sent by the NEF to the AF. Alternatively, the first key acquisition response carries the AKMA application key information of the AF.

In some examples, the NEF converts the received SUPI into a GPSI and sends the GPSI to the AF.

In some examples, in a case that the NEF does not receive the AKMA application key of the AF from the proxy entity or cannot generate the AKMA application key of the AF, the NEF sends an error response to the AF.

In some examples, the AF is a non-trusted application function outside a 3GPP service provider domain.

To sum up, the example of the disclosure provides the key management method. By interaction among the NEF, the AAnF as well as the AF in the home network and the proxy entity in the serving network, an application key request and an application key response can be realized, so that the NEF can acquire the AKMA application key information of the AF outside the 3GPP service provider domain.

### An Example of a Key Management Method Performed by an AF:

FIG. 9 shows a schematic diagram of a key management method provided by an example of the disclosure. This example takes the application of the method to an AF 05 as an example for explanation. The method includes at least part of the following steps:

step 910: a serving network identifier and an AKMA key identifier sent by a terminal 01a are received.

In some examples, the AF is a non-trusted application function outside a 3GPP service provider domain.

In some examples, a serving network identifier and/or an AKMA key identifier from a terminal are/is received by the AF. Alternatively, the AKMA key identifier is A-KID.

In some examples, an application session establishment request from the terminal is received by the AF. Alternatively, the application session establishment request carries the serving network identifier of the terminal.

In some examples, the application session establishment request includes the AKMA key identifier, and the AKMA key identifier carries the serving network identifier of the terminal; the application session establishment request includes the AKMA key identifier and the serving network identifier of the terminal; or, the application session establishment request includes the AKMA key identifier, and the AF receives the serving network identifier of the terminal before or after receiving the application session establishment request. Alternatively, the serving network identifier indicates the presence of a corresponding application session establishment request or the AKMA key identifier.

Step 930: the AKMA key identifier and the AF identifier are sent to the NEF 06 in the serving network.

In a case that the received serving network identifier of the terminal is different from the home network identifier of the terminal, the AKMA key identifier and the AF identifier are sent by the AF to the NEF in the serving network. Alternatively, the AKMA key identifier is A-KID. Alternatively, the AF identifier is an AF_ID.

In some examples, the AF first sends a key acquisition request to the NEF in the serving network, and the first key acquisition request carries the AKMA key identifier and the AF identifier.

In some examples, a proxy entity is integrated in the NEF in the serving network. Alternatively, the proxy entity is a proxy network element. Alternatively, the proxy entity is an AAnFProxy.

In some examples, the first key acquisition request is sent by the AF to the NEF in the serving network, and the first key acquisition request is used to trigger the NEF to send a second key acquisition request to the proxy entity. Alternatively, both the first key acquisition request and the second key acquisition request carry the AKMA key identifier and the AF identifier.

In some examples, the proxy entity is an entity different from the NEF in the serving network.

Step 950: AKMA application key information of the AF from the NEF 06 in the serving network is received.

The AKMA application key information of the AF from the proxy entity in the serving network is received by the AF.

In some examples, the AKMA application key information of the AF from the NEF includes at least one of the following information:
an AKMA application key of the AF;
an Exp Time of the AKMA application key;
a GPSI; or
an error response.

In some examples, a first key acquisition response from the proxy entity is received by the AF, and the first key acquisition response carries the AKMA application key information of the AF.

In some examples, the proxy entity is a part of the NEF in the serving network.

In some examples, the first key acquisition response sent by the NEF in the serving network is received by the AF, and the first key acquisition response is a key acquisition response sent by the NEF in the serving network after receiving a second key acquisition response sent by the proxy entity. Alternatively, both the first key acquisition response and the second key acquisition response carry the AKMA application key information of the AF; and
in some examples, the proxy entity is an entity different from the NEF in the serving network.

Step 970: an application session establishment response is fed back to the terminal 01a.

The AF triggers to send the application session establishment response to the terminal based on the received AKMA application key information of the AF or the first key acquisition response. The application session establishment response is response information of the AF to a received application session establishment request or the AKMA key identifier from the terminal.

In some examples, in a case that the AAnF in the home network determines that it cannot provide a service to the AF or the first key acquisition response indicates that the application session establishment fails, the AF rejects application session establishment and sends or does not send the application session establishment response to the terminal. Alternatively, the application session establishment response indicates that an AKMA key request fails. Alternatively, the application session establishment response includes a reason for the application session establishment failure.

In some examples, if the first key acquisition response indicates that the application session establishment is successful, the AF accepts the application session establishment and sends the application session establishment response to the terminal. Alternatively, the application session establishment response indicates that an AKMA key request is successful.

In some examples, the AF is a non-trusted application function outside a 3GPP service provider domain.

To sum up, the example of the disclosure provides the key management method. By interaction between the AF and the terminal as well as the NEF in the serving network, an application key request and an application key response can be realized, so that the terminal can acquire the AKMA application key information of the AF outside the 3GPP service provider domain.

### An Example of a Key Management Method Performed by an AAnF:

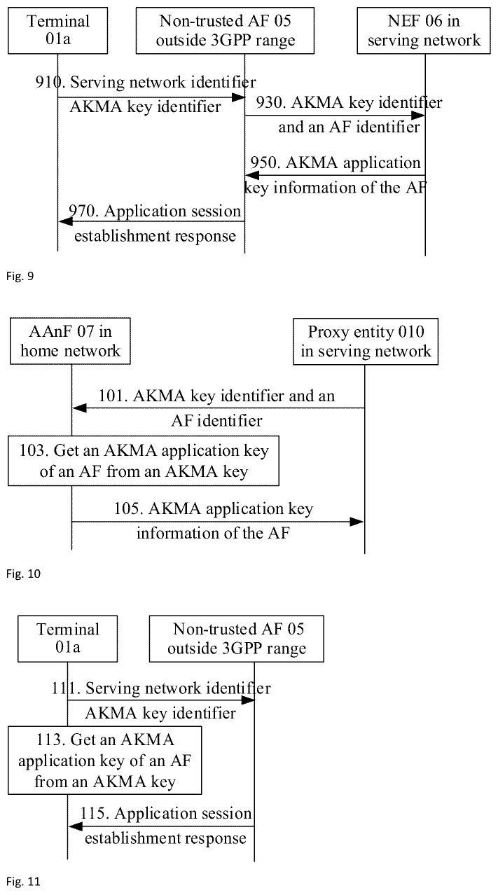

FIG. 10 shows a schematic diagram of a key management method provided by an example of the disclosure. This example takes the application of the method to an AAnF 07 in a home network as an example for explanation. The method includes at least part of the following steps:

Step 101: an AKMA key identifier and an AF identifier from a proxy entity 010 in a serving network are received.

The AKMA key identifier and the AF identifier from the proxy entity in the serving network are received by the AAnF in the home network, where the AKMA key identifier is used to indicate an AKMA key of a terminal, and the AF identifier is used to indicate an AF. Alternatively, the AKMA key identifier is A-KID, and the AF identifier is AF_ID.

In some examples, a third key acquisition request sent by the proxy entity in the serving network is received by the AAnF in the home network, the third key acquisition request is triggered and sent by the proxy entity upon receiving a second key acquisition request, and the second key acquisition request is triggered and sent by an NEF in the serving network upon receiving a first key acquisition request from the AF. Alternatively, the first key acquisition request, the second key acquisition request and the third key acquisition request all carry the AKMA key identifier and the AF identifier.

In some examples, the proxy entity is an entity different from the NEF in the serving network.

In some examples, a third key acquisition request sent by the proxy entity in the serving network is received by the AAnF in the home network, and the third key acquisition request is triggered and sent by the proxy entity upon receiving the first key acquisition request from the AF. Alternatively, both the first key acquisition request and the third key acquisition request carry the AKMA key identifier and the AF identifier.

In some examples, the proxy entity is a part of the NEF in the serving network.

Step 103: the AKMA application key of the AF is gotten from the AKMA key.

In some examples, whether the AAnF in the home network may provide a service to the AF and the proxy entity in the serving network is determined by the AAnF according to authorization information or policy provided by the AF identifier. Alternatively, the AF identifier is an AF_ID.

In some examples, the authorization information or policy is provided by a local policy or an NRF in the home network.

In a case of determining that the AAnF may provide the service to the AF and the proxy entity in the serving network, the AAnF performs the following process; and in a case that the AAnF cannot provide the service to the AF and the proxy entity in the service network, the AAnF rejects the following process.

In some examples, the AAnF determines whether there is a corresponding AKMA key locally according to a current AKMA key identifier. Alternatively, the AKMA key identifier is A-KID. Alternatively, the AKMA key is K_{AKMA}.

In a case that the AAnF does not have the AKMA key corresponding to the AKMA key identifier, the AAnF sends an error response; and in a case that the AAnF has the AKMA key corresponding to the AKMA key identifier, the AKMA application key of the AF is gotten by the AAnF from the AKMA key. A key source of the AKMA application key of the AF needs to be executed in accordance with Annex A.4 of TS 33.535.

Step 105: AKMA application key information of the AF is sent to the proxy entity 010 in the serving network.

The AKMA application key information of the AF is sent by the AAnF in the home network to the proxy entity in the serving network.

In some examples, the AKMA application key information of the AF includes at least one of the following information:
the AKMA application key of the AF;
an Exp Time of the AKMA application key;
an SUPI of the terminal; or
an error response.

In some examples, a third key acquisition response is sent by the AAnF in the home network to the proxy entity in the serving network, where the third key acquisition response is used to trigger the proxy entity to send a second key acquisition response to the NEF, and the second key acquisition response is used to trigger the NEF to send a first key acquisition response to the AF. Alternatively, the first key acquisition response, the second key acquisition response and the third key acquisition response all carry the AKMA application key information of the AF.

In some examples, the proxy entity is an entity different from the NEF in the serving network.

In some examples, the third key acquisition response is sent by the AAnF in the home network to the proxy entity in the serving network, and the third key acquisition response is used to trigger the proxy entity to send the first key acquisition response to the AF. Alternatively, both the first key acquisition response and the third key acquisition response carry the AKMA application key information of the AF.

In some examples, the proxy entity is a part of the NEF in the serving network.

In some examples, the AF is a non-trusted application function outside a 3GPP service provider domain.

To sum up, the example of the disclosure provides the key management method. By interaction between the AAnF and the proxy entity in the serving network, an application key request and an application key response can be realized, so that the proxy entity can acquire the AKMA application key information of the AF.

### An Example of a Key Management Method Performed by a Terminal:

FIG. 11 shows a schematic diagram of a key management method provided by an example of the disclosure. This example takes the application of the method to a terminal 01a as an example for explanation. The method includes at least part of the following steps:

step 111: a serving network identifier and/or an AKMA key identifier are/is sent to an AF 05.

The serving network identifier and/or the AKMA key identifier of the terminal are/is sent by the terminal to the AF, where the serving network identifier is used to trigger the AF to send the AKMA key identifier and an AF identifier to a proxy entity in a serving network in a case that the serving network identifier and a home network identifier are different. Alternatively, the AKMA key identifier is A-KID. Alternatively, the AF identifier is an AF_ID.

In some examples, an application session establishment request is sent by the terminal to the AF, and the application session establishment request carries the serving network identifier of the terminal.

In some examples, the application session establishment request includes the AKMA key identifier, and the AKMA key identifier carries the serving network identifier of the terminal; alternatively, the application session establishment request includes the AKMA key identifier and the serving network identifier of the terminal; alternatively, the application session establishment request includes the AKMA key identifier, and the serving network identifier is sent by the terminal to the AF before or after sending the application session establishment request. Alternatively, the serving network identifier indicates the presence of a corresponding application session establishment request and/or the AKMA key identifier.

Step 113: the AKMA application key of the AF is gotten from the AKMA key.

In some examples, the AKMA application key of the AF is gotten by the terminal from the AKMA key before or after sending the application session establishment request or the serving network identifier.

Step 115: an application session establishment response from the AF 05 is received.

The application session establishment response from the AF is received by the terminal. The application session establishment response is response information of the AF to a received application session establishment request or the AKMA key identifier from the terminal.

In some examples, the terminal receives the application session establishment response from the AF or does not receive the application session establishment response within a time x. Alternatively, the application session establishment response indicates that an AKMA key request fails. Alternatively, the application session establishment response includes a reason for the application session establishment failure.

In some examples, a value of x is predefined by the communication protocol, configured by the terminal, configured by the AF, or pre-configured.

In some examples, the application session establishment response from the AF is received by the terminal. Alternatively, the application session establishment response indicates that an AKMA key request is successful.

In some examples, the AF is a non-trusted application function outside a 3GPP service provider domain.

To sum up, the example of the disclosure provides the key management method. By interaction between the terminal and the AF, an application key request and an application key response can be realized, so that the terminal can acquire the AKMA application key information of the AF outside the 3GPP service provider domain.

FIG. 12 shows a structural block diagram of a key management apparatus provided by an example of the disclosure, and this apparatus includes at least some of the following modules:
a first receiving module 121, configured to receive an AKMA key identifier and an AF identifier from an AF, where the AKMA key identifier is used to indicate an AKMA key of a terminal, and the AF identifier is used to indicate the AF; and
a first sending module 123, configured to feed back AKMA application key information of the AF to the AF.

In some examples, the apparatus further includes: a processing module 125, configured to generate AKMA application key information of the AF;
or, the AKMA application key information of the AF is generated by an AKMA anchor function (AAnF) in a home network.

In some examples, the first sending module 123 is further configured to send the AKMA key identifier and the AF identifier to the AAnF in the home network; and
the first receiving module 121 is further configured to receive the AKMA application key information of the AF sent by the AAnF in the home network.

In some examples, the first receiving module 121 is further configured to receive a first key acquisition request sent by the AF, where the first key acquisition request carries the AKMA key identifier and the AF identifier.

In some examples, the first sending module 123 is further configured to send a first key acquisition response to the AF, where the first key acquisition response carries the AKMA application key information of the AF.

In some examples, the apparatus is a part of an NEF in a serving network.

In some examples, the first receiving module 121 is further configured to receive a second key acquisition request sent by an NEF in a serving network, where the second key acquisition request is a key acquisition request sent by the NEF in the serving network after receiving a first key acquisition request sent by the AF, where
both the first key acquisition request and the second key acquisition request carry the AKMA key identifier and the AF identifier.

In some examples, the first sending module 123 is further configured to send a second key acquisition response to the NEF in the serving network, where the second key acquisition response is used to trigger the NEF to send a first key acquisition response to the AF, where
both the first key acquisition response and the second key acquisition response carry the AKMA application key information of the AF.

In some examples, the apparatus is an entity different from the NEF in the serving network.

In some examples, the first sending module 123 is further configured to send a third key acquisition request to the AAnF in the home network, where the third key acquisition request carries the AKMA key identifier and the AF identifier.

In some examples, the AKMA application key information of the AF includes at least one of the following information:
an AKMA application key of the AF;
an expiration time of the AKMA application key;
a subscription permanent identifier (SUPI) of the terminal; or
an error response.

In some examples, the AKMA application key information of the AF includes at least one of the following information:
the AKMA application key of the AF;
the expiration time of the AKMA application key;
a generic public subscription identifier (GPSI) of the terminal; or
the error response.

In some examples, the AF is a non-trusted application function outside a 3GPP service provider domain.

To sum up, the example of the disclosure provides the key management apparatus. By interaction between the apparatus and the AAnF as well as the AF in the home network, an application key request and an application key response can be realized, so that the apparatus can acquire the AKMA application key information of the AF outside the 3GPP service provider domain.

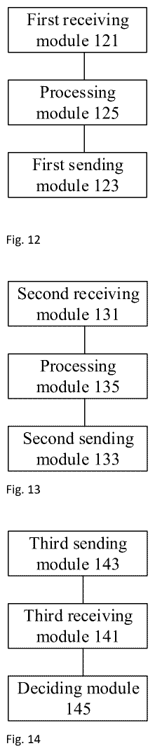

FIG. 13 shows a structural block diagram of a key management apparatus provided by an example of the disclosure, and this apparatus includes at least some of the following modules:
a second receiving module 131, configured to receive an AKMA key identifier and an AF identifier from an AF, where the AKMA key identifier is used to indicate an AKMA key of a terminal, and the AF identifier is used to indicate the AF; and
a second sending module 133, configured to feed back AKMA application key information of the AF to the AF.

In some examples, the apparatus further includes: a processing module 135, configured to generate AKMA application key information of the AF;
or, the AKMA application key information of the AF is generated by an AKMA anchor function (AAnF) in a home network.

In some examples, the second sending module 133 is further configured to send the AKMA key identifier and the AF identifier to the AAnF in the home network;
the second receiving module 131 is further configured to receive the AKMA application key information of the AF from the AAnF in the home network; and
the apparatus further includes: a processing module 135, configured to convert, in a case that the received AKMA application key information of the AF contains a subscription permanent identifier (SUPI) of the terminal, the SUPI into a generic public subscription identifier (GPSI) of the terminal.

In some examples, the second receiving module 131 is further configured to receive a first key acquisition request sent by the AF, where the first key acquisition request carries the AKMA key identifier and the AF identifier.

In some examples, the second sending module 133 is further configured to send a third key acquisition request to the AAnF in the home network, where the third key acquisition request carries the AKMA key identifier and the AF identifier.

In some examples, the second receiving module 131 is further configured to receive a third key acquisition response sent by the AAnF in the home network, where the third key acquisition response carries the AKMA application key information of the AF.

In some examples, a proxy entity is integrated in the apparatus.

In some examples, the AKMA application key information of the AF is generated by the proxy entity in a serving network;
or, the AKMA application key information of the AF is generated by an AKMA anchor function (AAnF) in a home network.

In some examples, the second receiving module 131 is further configured to receive the AKMA application key information of the AF from the proxy entity in the serving network; and
the apparatus further includes: a processing module 135, configured to convert, in a case that the received AKMA application key information of the AF contains a subscription permanent identifier (SUPI) of the terminal, the SUPI into a generic public subscription identifier (GPSI) of the terminal;
or,
the second sending module 133 is further configured to send the AKMA key identifier and the AF identifier to the AAnF in the home network;
the second receiving module 131 is further configured to receive the AKMA application key information of the AF from the AAnF in the home network; and
the apparatus further includes: a processing module 135, configured to convert, in a case that the received AKMA application key information of the AF contains a subscription permanent identifier (SUPI) of the terminal, the SUPI into a generic public subscription identifier (GPSI) of the terminal.

In some examples, the second sending module 133 is further configured to send a second key acquisition request to a proxy entity in a serving network, where the second key acquisition request is used to trigger the proxy entity to send a third key acquisition request to an AAnF in a home network, where
both the second key acquisition request and the third key acquisition request carry the AKMA key identifier and the AF identifier.

In some examples, the apparatus further includes a processing module 135, configured to select the proxy entity in the serving network.

In some examples, the processing module 135 is further configured to select the proxy entity according to a local preset policy, or select the proxy entity by using a network function repository function (NRF) in the serving network.

In some examples, the second receiving module 131 is further configured to receive a second key acquisition response sent by the proxy entity in the serving network, where the second key acquisition response is sent by the proxy entity in the serving network after receiving a third key acquisition response sent by the AAnF in the home network, where
both the second key acquisition response and the third key acquisition response carry the AKMA application key information of the AF.

In some examples, the proxy entity is an entity different from the apparatus in the serving network.

In some examples, the AKMA application key information of the AF or the AKMA application key information of the AF carried in the second key acquisition response or the AKMA application key information of the AF carried in the third key acquisition response includes at least one of the following information:
an AKMA application key of the AF;
an expiration time of the AKMA application key;
an SUPI of the terminal; or
an error response.

In some examples, the AKMA application key information of the AF includes at least one of the following information:
the AKMA application key of the AF;
the expiration time of the AKMA application key;
a GPSI of the terminal; or
the error response.

In some examples, the apparatus further includes a processing module 135, configured to convert the received SUPI into the GPSI.

In some examples, the AF is a non-trusted application function outside a 3GPP service provider domain.

To sum up, the example of the disclosure provides the key management apparatus. By interaction among the NEF, the AAnF as well as the AF in the home network and the proxy entity in the serving network, an application key request and an application key response can be realized, so that the NEF can acquire the AKMA application key information of the AF outside the 3GPP service provider domain.

FIG. 14 shows a structural block diagram of a key management apparatus provided by an example of the disclosure, and this apparatus includes at least some of the following modules:
a third receiving module 141, configured to receive a serving network identifier and an AKMA key identifier sent by a terminal; and
a third sending module 143, configured to send, in a case that the serving network identifier and a home network identifier of the terminal are different, the AKMA key identifier and an AF identifier to an NEF in a serving network; where
the third receiving module 141 is further configured to receive AKMA application key information of an AF from the NEF in the serving network; and
the third sending module 143 is further configured to feed back an application session establishment response to the terminal.

In some examples, the apparatus further includes a deciding module 145, configured to decide the NEF based on a serving network identifier.

In some examples, the third sending module 143 is further configured to send a first key acquisition request to the NEF in the serving network, where the first key acquisition request carries the AKMA key identifier and the AF identifier.

In some examples, the third receiving module 141 is further configured to receive a first key acquisition response from the NEF in the serving network, where the first key acquisition response carries the AKMA application key information of the AF.

In some examples, a proxy entity is integrated in the NEF in the serving network.

In some examples, the third sending module 143 is further configured to send a first key acquisition request to the NEF in the serving network, where the first key acquisition request is used to trigger the NEF to send a second key acquisition request to the proxy entity in the serving network, where
both the first key acquisition request and the second key acquisition request carry the AKMA key identifier and the AF identifier.

In some examples, the third receiving module 141 is further configured to receive a first key acquisition response sent by the NEF in the serving network, where the first key acquisition response is a key acquisition response sent by the NEF in the serving network after receiving a second key acquisition response sent by the proxy entity, where
both the first key acquisition response and the second key acquisition response carry the AKMA application key information of the AF.

In some examples, the proxy entity is an entity different from the NEF in the serving network.

In some examples, the third receiving module 141 is further configured to receive an application session establishment request sent by the terminal, where the application session establishment request carries the serving network identifier and the AKMA key identifier of the terminal.

In some examples, the application session establishment request includes the AKMA key identifier, and the AKMA key identifier carries the serving network identifier of the terminal;
or, the application session establishment request includes the AKMA key identifier and the serving network identifier of the terminal.

In some examples, the AKMA application key information of the AF includes at least one of the following information:
an AKMA application key of the AF;
an expiration time of the AKMA application key;
a GPSI of the terminal; or
an error response.

In some examples, the AKMA application key information of the AF includes at least one of the following information:
the AKMA application key of the AF;
the expiration time of the AKMA application key;
an SUPI of the terminal; or
the error response.

In some examples, the AF is a non-trusted application function outside a 3GPP service provider domain.

To sum up, the example of the disclosure provides the key management apparatus. By interaction between the AF and the terminal as well as the NEF in the serving network, an application key request and an application key response can be realized, so that the terminal can acquire the AKMA application key information of the AF outside the 3GPP service provider domain.

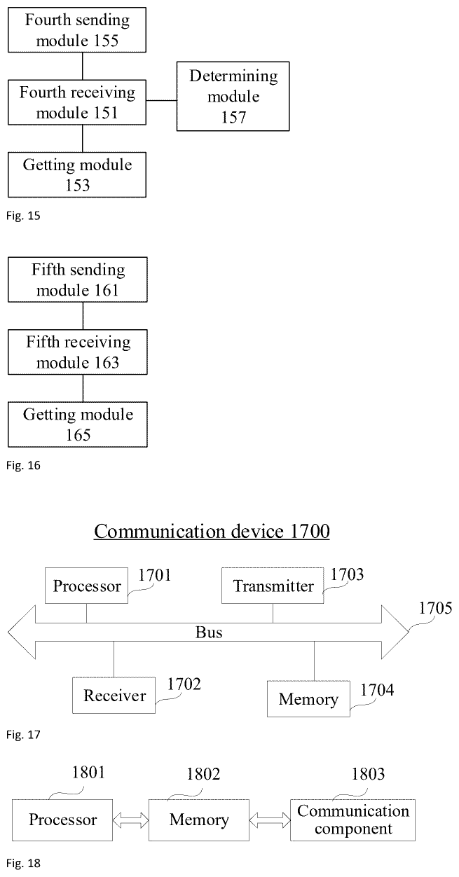

FIG. 15 shows a structural block diagram of a key management apparatus provided by an example of the disclosure, and this apparatus includes at least some of the following modules:
a fourth receiving module 151, configured to receive an AKMA key identifier and an AF identifier from a proxy entity in a serving network, where the AKMA key identifier is used to indicate an AKMA key of a terminal, and the AF identifier is used to indicate an AF;
a getting module 153, configured to get an AKMA application key of the AF based on an AKMA key indicated by the AKMA key identifier; and
a fourth sending module 155, configured to send AKMA application key information of the AF to the proxy entity in the serving network.

In some examples, the apparatus further includes a determining module 157, configured to determine whether the apparatus provides a service to the AF and the proxy entity in the serving network according to authorization information or policy;
the determining module 157 is further configured to generate, in a case that the AKMA key of the terminal is stored in the apparatus, the AKMA application key of the AF based on the AKMA key of the terminal; and
the determining module 157 is further configured to generate, in a case that the AKMA key of the terminal is stored in the apparatus and the apparatus provides a service to the AF and the proxy entity in the serving network, the AKMA application key of the AF based on the AKMA key of the terminal.

In some examples, the authorization information or policy is provided by a local policy or a network repository function (NRF) in the home network.

In some examples, the fourth receiving module 151 is further configured to receive a third key acquisition request sent by the proxy entity in the serving network, where the third key acquisition request is triggered and sent by the proxy entity upon receiving a second key acquisition request, and the second key acquisition request is triggered and sent by an NEF in the serving network upon receiving a first key acquisition request from the AF, where
the first key acquisition request, the second key acquisition request and the third key acquisition request all carry the AKMA key identifier and the AF identifier.

In some examples, the fourth sending module 155 is further configured to send a third key acquisition response to the proxy entity in the serving network, where the third key acquisition response is used to trigger the proxy entity to send a second key acquisition response to the NEF, and the second key acquisition response is used to trigger the NEF to send a first key acquisition response to the AF, where
the first key acquisition response, the second key acquisition response and the third key acquisition response all carry the AKMA application key information of the AF.

In some examples, the proxy entity is an entity different from the NEF in the serving network.

In some examples, the fourth receiving module 151 is further configured to receive a third key acquisition request sent by the proxy entity in the serving network, where the third key acquisition request is triggered and sent by the proxy entity upon receiving a first key acquisition request from the AF, where
both the first key acquisition request and the third key acquisition request carry the AKMA key identifier and the AF identifier.

In some examples, the fourth sending module 155 is further configured to send a third key acquisition response to the proxy entity in the serving network, where the third key acquisition response is used to trigger the proxy entity to send a first key acquisition response to the AF, where
both the first key acquisition response and the third key acquisition response carry the AKMA application key information of the AF.

In some examples, the proxy entity is a part of the NEF in the serving network.

In some examples, the AKMA application key information of the AF or the AKMA application key information of the AF carried in the third key acquisition response or the AKMA application key information of the AF carried in the second key acquisition response includes at least one of the following information:
an AKMA application key of the AF;
an expiration time of the AKMA application key;
an SUPI of the terminal; or
an error response.

In some examples, the AKMA application key information of the AF carried in the first key acquisition response includes at least one of the following information:
the AKMA application key of the AF;
the expiration time of the AKMA application key;
a GPSI of the terminal; or
the error response.

In some examples, the AF is a non-trusted application function outside a 3GPP service provider domain.

To sum up, the example of the disclosure provides the key management apparatus. By interaction between the AAnF and the proxy entity in the serving network, an application key request and an application key response can be realized, so that the proxy entity can acquire the AKMA application key information of the AF.

FIG. 16 shows a structural block diagram of a key management apparatus provided by an example of the disclosure, and this apparatus includes at least some of the following modules:
a fifth sending module 161, configured to send a serving network identifier and an AKMA key identifier to an AF, where the serving network identifier is used to trigger the AF to send the AKMA key identifier and an AF identifier to a proxy entity in a serving network in a case that the serving network identifier and a home network identifier are different.

In some examples, the fifth sending module 161 is further configured to send an application session establishment request to the AF, where the application session establishment request carries the serving network identifier and the AKMA key identifier of a terminal.

In some examples, the application session establishment request includes the AKMA key identifier, and the AKMA key identifier carries the serving network identifier of the terminal;
or, the application session establishment request includes the AKMA key identifier and the serving network identifier of the terminal.

In some examples, the apparatus further includes a fifth receiving module 163, configured to receive an application session establishment response from the AF.

In some examples, the apparatus further includes a getting module 165, configured to get an AKMA application key of the AF based on an AKMA key indicated by the AKMA key identifier.

In some examples, the AF is a non-trusted application function outside a 3GPP service provider domain.

To sum up, the example of the disclosure provides the key management apparatus. By interaction with the AF, an application key request and an application key response can be realized, so that the apparatus can acquire the AKMA application key information of the AF outside the 3GPP service provider domain.

It is to be noted that the apparatus provided by the above examples are merely illustrated by dividing the various functional modules above. In practical application, the above functions may be allocated to be completed by the different functional modules according to actual needs. That is, an internal structure of the device is divided into the different functional modules to complete all or part of the functions described above.

As for the apparatus in this example, the specific manners for executing operations by each module have been described in the examples related to the method in detail, which is not illustrated in detail here.

FIG. 17 shows a schematic structural diagram of a communication device (a terminal or a network device) provided by an example of the disclosure. The communication device 1700 includes: a processor 1701, a receiver 1702, a transmitter 1703, a memory 1704 and a bus 1705.

The processor 1701 includes one or more processing cores, and the processor 1701 executes various functional applications and information processing by running software programs and modules.

The receiver 1702 and the transmitter 1703 may be implemented as a communication component, which may be a communication chip.

The memory 1704 is connected with the processor 1701 through the bus 1705. The memory 1704 may be configured to store at least one instruction, and the processor 1701 is configured to execute the at least one instruction, so as to implement various steps in the above method examples.

Additionally, the memory 1704 may be implemented by any type of volatile or nonvolatile storage devices or their combinations, and the volatile or nonvolatile storage devices include but are not limited to: a magnetic disk or an optical disk, an electrically erasable programmable read only memory (EEPROM), an erasable programmable read-only memory (EPROM), a static random-access memory (SRAM), a read-only memory (ROM), a magnetic memory, a flash memory, and a programmable read-only memory (PROM).

FIG. 18 shows a schematic structural diagram of a network element device provided by an example of the disclosure. The network element device includes: a processor 1801, a memory 1802, and a communication component 1803.

The processor 1801 is connected with the memory 1802, and the memory 1802 is connected with the communication component 1803.

The memory 1802 may be configured to store at least one instruction and a computer program, and the processor 1801 is configured to execute the at least one instruction and the computer program, so as to implement processing steps of the key management method performed by the core network element in the above method examples. The processing steps refer to other steps besides a receiving step and a sending step.

The communication component 1803 is used to implement the receiving step and the sending step of the key management method performed by the core network element in the above method examples.

An example of the disclosure further provides a proxy entity, the proxy entity includes a communication component, where the communication component is configured to receive an AKMA key identifier and an AF identifier from an AF, where the AKMA key identifier is used to indicate an AKMA key of a terminal, and the AF identifier is used to indicate the AF; and feed back AKMA application key information of the AF to the AF.

An example of the disclosure further provides a network exposure function (NEF), the NEF includes a communication component, where the communication component is configured to receive an authentication and key management for applications (AKMA) key identifier and an AF identifier from an AF, where the AKMA key identifier is used to indicate an AKMA key of a terminal, and the AF identifier is used to indicate the AF; and feed back AKMA application key information of the AF to the AF.

An example of the disclosure further provides an application function (AF), the AF includes a communication component, where the communication component is configured to receive a serving network identifier and an AKMA key identifier sent by a terminal; send, in a case that the serving network identifier and a home network identifier of the terminal are different, the AKMA key identifier and an AF identifier to an NEF in a serving network; receive AKMA application key information of an AF from the NEF in the serving network; and feed back an application session establishment response to the terminal.

An example of the disclosure further provides an authentication and key management for applications (AKMA) anchor function (AAnF), the AAnF includes a communication component and a processor, where the communication component is configured to receive an AKMA key identifier and an AF identifier from a proxy entity in a serving network, where the AKMA key identifier is used to indicate an AKMA key of a terminal, and the AF identifier is used to indicate an AF; the processor is configured to get an AKMA application key of the AF based on the AKMA key indicated by the AKMA key identifier; and the communication component is further configured to send AKMA application key information of the AF to the proxy entity in the serving network.

An example of the disclosure further provides a terminal, the terminal includes a transceiver, where the transceiver is configured to send a serving network identifier and an AKMA key identifier to an AF, where the serving network identifier is used to trigger the AF to send the AKMA key identifier and an AF identifier to a proxy entity in a serving network in a case that the serving network identifier and a home network identifier are different.

In an example, a non-transitory computer readable storage medium is further provided. The non-transitory computer readable storage medium stores at least one program. The at least one program is loaded and executed by a processor to implement the key management method provided by each of the above method examples.

In an example, a chip is further provided. The chip includes a programmable logic circuit and/or program instructions, and the chip, when running on a communication device, is configured to implement the key management method provided by each of the foregoing method examples.

In an example, a computer program product is further provided, and the computer program product, when running on a processor of a computer device, causes the computer device to execute the key management method provided by the various method examples above.

The technical solutions provided by the examples of the disclosure at least include the following beneficial effects:
the key management method applied in the roaming scenario is provided, and by interaction among the proxy entity in the serving network, an AKMA anchor network element in the home network and the AF outside the 3GPP service provider domain, an application key request and an application key response can be realized, so that the terminal and the application function outside the 3GPP service provider domain perform an AKMA service.

Those skilled in the art may realize that, in one or more of the above examples, the functions described in the examples of the disclosure may be implemented by hardware, software, firmware, or any combination thereof. In response to being implemented in software, these functions may be stored in a computer readable medium or serve as one or more instructions or code on the computer readable medium to be transmitted. The computer readable medium includes a computer storage medium and a communication medium, where the communication medium includes any medium that facilitates transfer of a computer program from one place to another. The storage medium may be any available medium that can be accessed by a general purpose or special purpose computer.

The above is merely an optional example of the disclosure and is not intended to limit the disclosure. Any modification, equivalent substitution, improvement, and the like made within the spirit and principle of the disclosure shall all be included in the protection scope of the disclosure.

1. A method for key management in a roaming scenario performed by a proxy entity in a serving network, the method comprising:
receiving an authentication and key management for applications (AKMA) key identifier and an application function (AF) identifier from an AF, wherein the AKMA key identifier is used to indicate an AKMA key of a terminal, and the AF identifier is used to indicate the AF; and
feeding back AKMA application key information of the AF to the AF.

2. The method according to claim 1, wherein
the AKMA application key information of the AF is generated by the proxy entity in the serving network;
or, the AKMA application key information of the AF is generated by an AKMA anchor function (AAnF) in a home network,
and the method further comprises:
sending the AKMA key identifier and the AF identifier to the AAnF in the home network; and
receiving the AKMA application key information of the AF sent by the AAnF in the home network;
wherein sending the AKMA key identifier and the AF identifier to the AAnF in the home network comprises:
sending a third key acquisition request to the AAnF in the home network, wherein the third key acquisition request carries the AKMA key identifier and the AF identifier.

3. (canceled)

4. The method according to claim 1, wherein receiving the AKMA key identifier and the AF identifier from the AF comprises:
receiving a first key acquisition request sent by the AF, wherein the first key acquisition request carries the AKMA key identifier and the AF identifier;
wherein feeding back AKMA application key information of the AF to the AF comprises:
sending a first key acquisition response to the AF, wherein the first key acquisition response carries the AKMA application key information of the AF;
wherein the proxy entity is a part of a network exposure function (NEF) in the serving network;
or;
wherein receiving the AKMA key identifier and the AF identifier from the AF comprises:
receiving a second key acquisition request sent by the network exposure function (NEF) in the serving network, wherein the second key acquisition request is a key acquisition request sent by the NEF in the serving network after receiving the first key acquisition request sent by the AF, wherein
both the first key acquisition request and the second key acquisition request carry the AKMA key identifier and the AF identifier;
wherein feeding back AKMA application key information of the AF to the AF comprises:
sending a second key acquisition response to the NEF in the serving network, wherein the second key acquisition response is used to trigger the NEF to send the first key acquisition response to the AF, wherein
both the first key acquisition response and the second key acquisition response carry the AKMA application key information of the AF;
wherein the proxy entity is an entity different from the NEF in the serving network.

5-10. (canceled)

11. The method according to claim 2, wherein the AKMA application key information of the AF or the AKMA application key information of the AF carried in a second key acquisition response comprises at least one of the following information:
an AKMA application key of the AF;
an expiration time of the AKMA application key;
a subscription permanent identifier (SUPI) of the terminal; or
an error response;
or,
wherein the AKMA application key information of the AF or the AKMA application key information of the AF carried in a first key acquisition response comprises at least one of the following information:
an AKMA application key of the AF;
an expiration time of the AKMA application key;
a generic public subscription identifier (GPSI) of the terminal; or
an error response;
wherein the AF is a non-trusted application function outside a 3GPP operator domain.

12-13. (canceled)

14. A method for key management in a roaming scenario performed by a network exposure function (NEF) in a serving network, the method comprising:
receiving an authentication and key management for applications (AKMA) key identifier and an application function (AF) identifier from an AF, wherein the AKMA key identifier is used to indicate an AKMA key of a terminal, and the AF identifier is used to indicate the AF; and
feeding back AKMA application key information of the AF to the AF.

15. The method according to claim 14, wherein
the AKMA application key information of the AF is generated by the NEF in the serving network;
or, the AKMA application key information of the AF is generated by an AKMA anchor function (AAnF) in a home network,
and the method further comprises:
sending the AKMA key identifier and the AF identifier to the AAnF in the home network;
receiving the AKMA application key information of the AF from the AAnF in the home network; and
converting, in a case that the received AKMA application key information of the AF contains a subscription permanent identifier (SUPI) of the terminal, the SUPI into a generic public subscription identifier (GPSI) of the terminal;
wherein sending the AKMA key identifier and the AF identifier to an AAnF in the home network comprises:
sending a third key acquisition request to the AAnF in the home network, wherein the third key acquisition request carries the AKMA key identifier and the AF identifier;
wherein receiving the AKMA application key information of the AF from the AAnF in the home network comprises:
receiving a third key acquisition response sent by the AAnF in the home network, wherein the third key acquisition response carries the AKMA application key information of the AF;
wherein a proxy entity is integrated in the NEF;
or;
wherein sending the AKMA key identifier and the AF identifier to the AAnF in the home network comprises:
sending a second key acquisition request to a proxy entity in the serving network, wherein the second key acquisition request is used to trigger the proxy entity to send the third key acquisition request to an AAnF in the home network, wherein both the second key acquisition request and the third key acquisition request carry the AKMA key identifier and the AF identifier;
wherein before sending the third key acquisition request to the AAnF in the home network, the method further comprises:
selecting the proxy entity in the serving network;
wherein selecting the proxy entity in the serving network comprises:
selecting the proxy entity according to a local preset policy: or
selecting the proxy entity by using a network function repository function (NRF) in the serving network;
wherein receiving the AKMA application key information of the AF from the AAnF in the home network comprises:
receiving a second key acquisition response sent by the proxy entity in the serving network, wherein the second key acquisition response is sent by the proxy entity in the serving network after receiving the third key acquisition response sent by the AAnF in the home network, wherein
both the second key acquisition response and the third key acquisition response carry the AKMA application key information of the AF;
wherein the proxy entity is an entity different from the NEF in the serving network.

16. (canceled)

17. The method according to claim 14, wherein receiving the AKMA key identifier and the AF identifier from the AF comprises:
receiving a first key acquisition request sent by the AF, wherein the first key acquisition request carries the AKMA key identifier and the AF identifier.

18-20. (canceled)

21. The method according to claim 14, wherein
the AKMA application key information of the AF is generated by a proxy entity in the serving network;
or, the AKMA application key information of the AF is generated by an AKMA anchor function (AAnF) in a home network;
wherein the method further comprises:
receiving the AKMA application key information of the AF from the proxy entity in the serving network; and
converting, in a case that the received AKMA application key information of the AF contains a subscription permanent identifier (SUPI) of the terminal, the SUPI into a generic public subscription identifier (GPSI) of the terminal;
or,
sending the AKMA key identifier and the AF identifier to the AAnF in the home network;
receiving the AKMA application key information of the AF from the AAnF in the home network; and
converting, in the case that the received AKMA application key information of the AF contains the subscription permanent identifier (SUPI) of the terminal, the SUPI into the generic public subscription identifier (GPSI) of the terminal.

22-27. (canceled)

28. The method according to claim 15, wherein the AKMA application key information of the AF or the AKMA application key information of the AF carried in the second key acquisition response or the AKMA application key information of the AF carried in the third key acquisition response comprises at least one of the following information:
an AKMA application key of the AF;
an expiration time of the AKMA application key;
a subscription permanent identifier (SUPI) of the terminal; or
an error response;
or,
wherein the AKMA application key information of the AF comprises at least one of the following information:
an AKMA application key of the AF;
an expiration time of the AKMA application key;
a generic public subscription identifier (GPSI) of the terminal; or
an error response;
wherein the method further comprises:
the GPSI is obtained by converting the received subscription permanent identifier (SUPI);
wherein the AF is a non-trusted application function outside a 3GPP service provider domain.

29-31. (canceled)

32. A method for key management in a roaming scenario performed by an application function (AF), the method comprising:
receiving a serving network identifier and an authentication and key management for applications (AKMA) key identifier sent by the terminal;
sending, in a case that the serving network identifier and a home network identifier of the terminal are different, the AKMA key identifier and an AF identifier to a network exposure function (NEF) in the serving network;
receiving AKMA application key information of the AF from the NEF in the serving network, wherein the AKMA application key information is fed back by the NEF according to the method of claim 14; and
feeding back an application session establishment response to the terminal.

33. The method according to claim 32, wherein the NEF is determined by the AF based on the serving network identifier;
wherein sending the AKMA key identifier and the AF identifier to the NEF in the serving network comprises:
sending a first key acquisition request to the NEF in the serving network, wherein the first key acquisition request carries the AKMA key identifier and the AF identifier;
wherein receiving the AKMA application key information of the AF from the NEF in the serving network comprises:
receiving a first key acquisition response from the NEF in the serving network, wherein the first key acquisition response carries the AKMA application key information of the AF;
wherein a proxy entity is integrated in the NEF in the serving network.

34-36. (canceled)

37. The method according to claim 32, wherein sending the AKMA key identifier and the AF identifier to a proxy entity in the serving network comprises:
sending a first key acquisition request to the NEF in the serving network, wherein the first key acquisition request is used to trigger the NEF to send a second key acquisition request to the proxy entity in the serving network, wherein
both the first key acquisition request and the second key acquisition request carry the AKMA key identifier and the AF identifier;
wherein receiving the AKMA application key information of the AF from the proxy entity in the serving network comprises:
receiving a first key acquisition response sent by the NEF in the serving network, wherein the first key acquisition response is a key acquisition response sent by the NEF in the serving network after receiving a second key acquisition response sent by the proxy entity, wherein both the first key acquisition response and the second key acquisition response carry the AKMA application key information of the AF;
wherein the proxy entity is an entity different from the NEF in the serving network;
wherein receiving the serving network identifier and the AKMA key identifier sent by the terminal comprises:
receiving an application session establishment request sent by the terminal, wherein the application session establishment request carries the serving network identifier and the AKMA key identifier of the terminal;
the application session establishment request comprises the AKMA key identifier, and the AKMA key identifier carries the serving network identifier of the terminal; or, the application session establishment request comprises the AKMA key identifier and the serving network identifier of the terminal.

38-44. (canceled)

45. A method for key management in the roaming scenario performed by an authentication and key management for applications (AKMA) anchor function (AAnF), the method comprising:
receiving an AKMA key identifier and an application function (AF) identifier from the proxy entity in the serving network, wherein the AKMA key identifier is used to indicate the AKMA key of the terminal, and the AF identifier is used to indicate the AF;
getting an AKMA application key of the AF based on Tehama key indicated by the AKMA key identifier; and
sending AKMA application key information of the AF to the proxy entity in the serving network, and cause the proxy entity to performs the step of feeding back AKMA application key information of the AF to the AF according to the method of claim 1.

46. The method according to claim 45, wherein the method further comprises:
determining whether an AAnF in a home network provides a service to the AF and the proxy entity in the serving network according to authorization information or policy, wherein
generating, in a case that the AKMA key of the terminal is stored in the AAnF of the home network, the AKMA application key of the AF based on the AKMA key of the terminal comprises:
generating, in a case that the AKMA key of the terminal is stored in the AAnF of the home network and the AAnF in the home network provides a service to the AF and the proxy entity in the serving network, the AKMA application key of the AF based on the AKMA key of the terminal;
the authorization information or policy is provided by a local policy or a network repository function (NRF) in the home network.

47. (canceled)

48. The method according to claim 45, wherein receiving the AKMA key identifier and the AF identifier comprises:
receiving a third key acquisition request sent by the proxy entity in the serving network, wherein the third key acquisition request is triggered and sent by the proxy entity upon receiving a second key acquisition request, and the second key acquisition request is triggered and sent by a network exposure function (NEF) in the serving network upon receiving a first key acquisition request from the AF, wherein
the first key acquisition request, the second key acquisition request and the third key acquisition request all carry the AKMA key identifier and the AF identifier;
wherein sending the AKMA application key information of the AF comprises:
sending a third key acquisition response to the proxy entity in the serving network, wherein the third key acquisition response is used to trigger the proxy entity to send a second key acquisition response to the NEF, and the second key acquisition response is used to trigger the NEF to send a first key acquisition response to the AF, wherein
the first key acquisition response, the second key acquisition response and the third key acquisition response all carry the AKMA application key information of the AF;
wherein the proxy entity is an entity different from the NEF in the serving network;
or;
wherein receiving the AKMA key identifier and the AF identifier comprises:
receiving a third key acquisition request sent by the proxy entity in the serving network, wherein the third key acquisition request is triggered and sent by the proxy entity upon receiving a first key acquisition request from the AF, wherein both the first key acquisition request and the third key acquisition request carry the AKMA key identifier and the AF identifier;
wherein sending the AKMA application key information of the AF comprises:
sending a third key acquisition response to the proxy entity in the serving network, wherein the third key acquisition response is used to trigger the proxy entity to send a first key acquisition response to the AF, wherein both the first key acquisition response and the third key acquisition response carry the AKMA application key information of the AF;
wherein the proxy entity is a part of an NEF in the serving network.

49-56. (canceled)

57. A method for key management in a roaming scenario performed by a terminal, the method comprising:
sending a serving network identifier and an authentication and key management for applications (AKMA) key identifier to an application function (AF), wherein the serving network identifier is used to trigger the AF to send the AKMA key identifier and an AF identifier to a proxy entity in a serving network in a case that the serving network identifier and a home network identifier are different.

58. The method according to claim 57, wherein sending the serving network identifier to the AF comprises:
sending an application session establishment request to the AF, wherein the application session establishment request carries the serving network identifier and the AKMA key identifier of the terminal;
wherein the method further comprises:
receiving an application session establishment response from the AF;
wherein the method further comprises:
getting an AKMA application key of the AF based on an AKMA key indicated by the AKMA key identifier.

59. The method according to claim 58, wherein
the application session establishment request comprises the AKMA key identifier, and the AKMA key identifier carries the serving network identifier of the terminal;
or,
the application session establishment request comprises the AKMA key identifier and the serving network identifier of the terminal;
wherein the AF is a non-trusted application function outside a 3GPP service provider domain.

60-124. (canceled)

125. An apparatus, comprising:
a memory that stores instructions;
one or more processors communicatively coupled to the memory,
wherein the instructions when collectively executed by the one or more processors cause the apparatus to act as the proxy entity and
perform the method according to claim 1.

126-129. (canceled)

130. A non-transitory computer readable storage medium,
wherein the non-transitory computer readable storage medium stores executable instructions, and the executable instructions when executed by a processor of the proxy entity, cause the proxy entity to perform the method according to claim 1.

131-132. (canceled)
